(19) United States
(12) Patent Application Publication
(10) Pub. No.: US 2025/0271131 A1
(43) Pub. Date: Aug. 28, 2025

(54) ELECTRIC VEHICLE CHARGING STATION

(71) Applicant: M3 Innovation, LLC, Syracuse, NY (US)

(72) Inventors: Christopher D. Nolan, Camillus, NY (US); Joseph R. Casper, Baldwinsville, NY (US)

(73) Assignee: M3 Innovation, LLC, Syracuse, NY (US)

(21) Appl. No.: 19/067,167

(22) Filed: Feb. 28, 2025

Related U.S. Application Data
(60) Provisional application No. 63/559,120, filed on Feb. 28, 2024.

(51) Int. Cl. F21V 33/00; B60L 53/18; B60L 53/53; B60L 53/67; B60L 53/68; B60L 55/00; F21S 2/00; F21S 8/08; F21S 9/02; H02J 3/32

(52) U.S. Cl. CPC F21V 33/006; B60L 53/18; B60L 53/53; B60L 53/67; B60L 53/68; B60L 55/00; F21S 2/005; F21S 8/086; F21S 9/02; H02J 3/322

(57) ABSTRACT

An electrical vehicle charging system having a lighting system having a controller stack connected to a lighting module, an auxiliary lighting module by wiring, an alternating current power supply, a switching circuit, a local power storage device, and a wireless communication gateway. The electrical vehicle charging system further having a plurality of electrical vehicle chargers each having an electrical vehicle charging cable configured for connection to an electrical vehicle; a connection to an existing power grid; an internet of things module configured for two-way, wireless communication with the wireless gateway; a feedback system; and a control system connected to and configured for communication with the internet of things module, the existing power grid, and the electrical vehicle charging cable.

This application claims priority under 35 U.S.C. § 119 to U.S. Provisional Application No. 63/559,120, filed Feb. 28, 2024, which is herein incorporated by reference in its entirety. This application incorporates U.S. application Ser. No. 18/913,748, filed Nov. 13, 2024, by reference in its entirety.

### BACKGROUND OF THE INVENTION

### Technical Field

The present invention relates to devices, systems, and methods for electrical vehicle charging stations and, more specifically, to electrical vehicle charging stations integrated with sports field and stadium lighting systems featuring modular auxiliary lighting systems employing asymmetric illumination sources.

### Background Information

At sports fields and stadiums, lighting systems are employed to allow sports and other events to continue after sunset or indoors. Whether by accepted standards or law, in the event of an emergency where there is a loss of power to the main lighting systems, facilities are equipped with auxiliary or emergency lighting to allow the patrons of the facility to move to safety. Many municipal sports fields as well as elementary to high-school level venues fail to provide efficient and effective lighting systems in the event of a loss of power. When there is a loss of power to the main lighting system, a generator is often used to switch on to power a separate system of emergency lights. This system is slow to switch on, requires a lot of space for generators, is expensive, and can be noisy.

More efficient systems may provide emergency lighting below a threshold where the power source is a battery. With more efficient stadium lighting systems, once the emergency battery is charged, electricity demand may be low, compared to existing stadium lighting systems.

With increased concerns of global warming, there is diminished fossil fuel consumption and a shift to more renewable sources. With this push, people are also attempting to make energy consumption more efficient, and manufacturers are making and selling more cars powered by electricity. Despite both a government and a public push, the infrastructure for charging electric cars is currently lacking.

### SUMMARY OF THE INVENTION

The present disclosure is directed toward systems, methods, and devices, providing electrical vehicle charging.

In one aspect of the present disclosure provided herein, is an electrical vehicle charging system having a lighting system having a controller stack connected to a lighting module, an auxiliary lighting module by wiring, an alternating current power supply, a switching circuit, a local power storage device, and a wireless communication gateway. The electrical vehicle charging system further having a plurality of electrical vehicle chargers each having an electrical vehicle charging cable configured for connection to an electrical vehicle; a connection to an existing power grid; an internet of things module configured for two-way, wireless communication with the wireless gateway; a feedback system; and a control system connected to and configured for communication with the internet of things module, the existing power grid, and the electrical vehicle charging cable.

In one aspect of the present disclosure provided herein, is a lighting system, having at least one lighting module, the lighting module having a housing extending from first end to a second end along a longitudinal axis and having an elongated opening in alignment with an illumination source therein; a first coupler positioned at the first end of the housing and has an end face having a first set of electrical contacts and a first set of auxiliary electrical contacts; and a second coupler positioned at the second end of the housing and an internal bore having a second set of electrical contacts and a second set of auxiliary electrical contacts within the internal bore. The lighting system further has an auxiliary lighting module, having a housing having an opening and an illumination source therein, and a coupler connected to the auxiliary lighting module housing having a set of auxiliary module electrical contacts and the coupler configured for connection to one of the first coupler or the second coupler; and a local power storage device. The lighting system further has a controller stack connected to the at least one lighting module by a first set of wiring, and connected to the auxiliary lighting module by a second set of wiring, the controller stack having: an alternating current power supply; a wireless gateway; and a switching circuit having a voltage monitor connecting the alternating current power supply and the first set of wiring, and the local power storage device and the second set of wiring, the voltage monitor measuring for a voltage drop threshold. The first set of electrical contacts are connected to the second set of electrical contacts internally of the lighting module housing, and the second set of wiring connects the first set of auxiliary electrical contacts and the second set of auxiliary electrical contacts. The lighting system further has a plurality of electrical vehicle chargers each connected to the controller stack having: an electrical vehicle charging cable configured for connection to an electrical vehicle; a connection to an existing power grid; an internet of things module configured for two-way, wireless communication with a wireless gateway; a feedback system; a control system connected to and configured for communication with the internet of things module, the existing power grid, and the electrical vehicle charging cable.

These, and other objects, features and advantages of this invention will become apparent from the following detailed description of the various aspects of the invention taken in conjunction with the accompanying drawings.

### BRIEF DESCRIPTION OF THE DRAWINGS

The present invention will be more fully understood and appreciated by reading the following Detailed Description in conjunction with the accompanying drawings, in which:

FIG. 1 is a perspective view of an asymmetric source sports lighting system in accordance with an aspect of the present invention;

FIG. 2 is a perspective view of the upper portion of a support pole of an asymmetric source sports lighting system in accordance with an aspect of the present invention;

FIG. 3 is a perspective view of the asymmetric lighting source for a lighting module in accordance with an aspect of the present invention;

FIG. 4 is a mechanical view of the light emitting diode (LED) layout for an asymmetric lighting source in accordance with an aspect of the present invention;

FIG. 5 is schematic of the electronics for an asymmetric lighting source in accordance with an aspect of the present invention;

FIG. 6 is a perspective view of a lighting module in accordance with an aspect of the present invention having a lens array thereon;

FIG. 7 is a perspective view of the male and female couplers of a lighting module in accordance with an aspect of the present invention;

FIG. 8 is a cross-sectional view of the male and female couplers of a lighting module in accordance with an aspect of the present invention;

FIG. 9 is a perspective view of a coupler clamp for securing lighting modules to each other in accordance with an aspect of the present invention

FIG. 10 is cross-sectional view of a lighting module to lighting module connection in accordance with an aspect of the present invention;

FIG. 11 is an electrical diagram of a lighting module to lighting module connection in accordance with an aspect of the present invention;

FIG. 12 is two perspective views of a mount in accordance with an aspect of the present invention;

FIG. 13 is an electrical diagram of a lighting module to mount connection in accordance with an aspect of the present invention;

FIG. 14 is a perspective view showing axial rotation of a series of interconnected lighting modules in accordance with an aspect of the present invention;

FIG. 15 is a perspective view of a controller stack in accordance with an aspect of the present invention;

FIG. 16 is a perspective view of a core enclosure in accordance with an aspect of the present invention;

FIG. 17 is high level schematic for a lighting system in accordance with an aspect of the present invention;

FIG. 18 is a detailed schematic of a master controller in accordance with an aspect of the present invention;

FIG. 19 is a detailed schematic of a core enclosure in accordance with an aspect of the present invention

FIG. 20 is a schematic of wireless monitoring and control approach in accordance with an aspect of the present invention; and

FIG. 21 is a schematic of beam steering using a lighting system in accordance with an aspect of the present invention;

FIG. 22 is a schematic of beam angles changes using a lighting system in accordance with an aspect of the present invention;

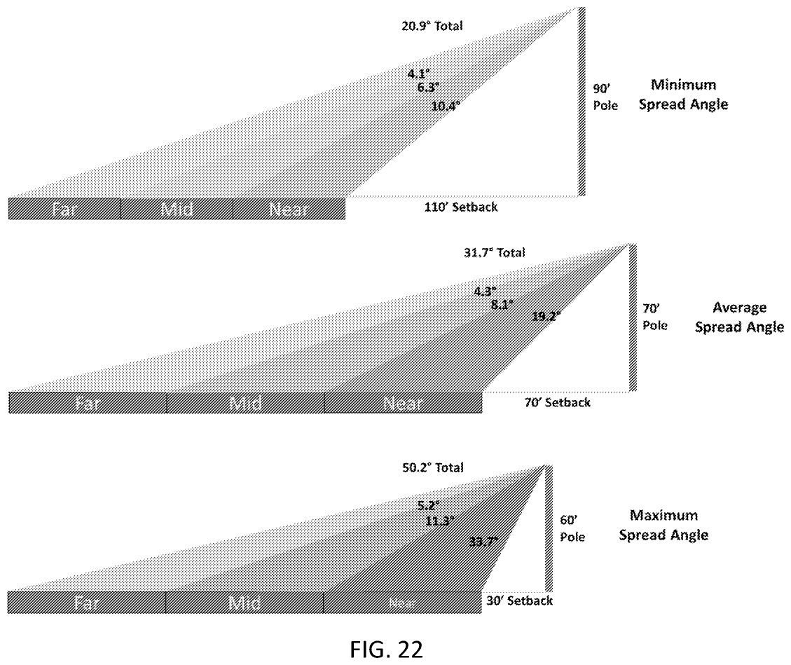

FIG. 23 is a schematic of tunable cut-off in a lighting system in accordance with an aspect of the present invention;

FIG. 24 is a perspective view of an environmental sealing system for a lighting module in accordance with an aspect of the present invention;

FIG. 25 is a front view of an environmental sealing system for a lighting module in accordance with an aspect of the present invention;

FIG. 26 is a side view of a micro-lens for a lighting module in accordance with an aspect of the present invention;

FIG. 27 is a first view of illumination steering using a lens array in accordance with an aspect of the present invention;

FIG. 28 is a second view of illumination steering using a lens array in accordance with an aspect of the present invention;

FIG. 29 is a third view of illumination steering using a lens array in accordance with an aspect of the present invention; and

FIG. 30 is a fourth view of illumination steering using a lens array in accordance with an aspect of the present invention.

### DETAILED DESCRIPTION OF THE INVENTION

The present invention will be discussed in detail in terms of various exemplary embodiments according to the present invention with reference to the accompanying drawings. In the following detailed description, numerous specific details are set forth to provide a thorough understanding of the present invention. To those skilled in the art, it will be obvious that the present invention may be practiced without these specific details. Similarly, well-known structures are not described to avoid obscuring the present invention.

Thus, the implementations described below are exemplary implementations provided to enable persons skilled in the art to make or use the embodiments of the disclosure and are not intended to limit the scope of the disclosure, which is defined by the claims.

Furthermore, there is no intention to be bound by any expressed or implied theory presented in the preceding technical field, background, summary, or the following detailed description. It is also to be understood that the specific devices and processes illustrated in the attached drawings, and described in the following specification, are simply exemplary embodiments of the inventive concepts defined in the claims. Specific dimensions and other physical characteristics relating to the embodiments disclosed are not to be considered as limiting, unless the claims expressly state so.

Likewise, the various figures, steps, procedures, and workflows are presented only as an example and in no way limit the systems, methods, or apparatuses described to perform their respective tasks or outcomes in different timeframes or orders. Unless expressly stated, any method set forth herein shall not be construed as requiring that its steps be performed in a specific order. The teachings of the present invention may be applied to any asymmetric lighting system that has or is integrated with an auxiliary lighting system.

The various embodiments described herein provide for systems, devices, and methods for asymmetric lighting systems that have or are integrated with auxiliary lighting systems: particularly, for lighting systems for sports and auxiliary lighting systems for asymmetric source sports lighting systems.

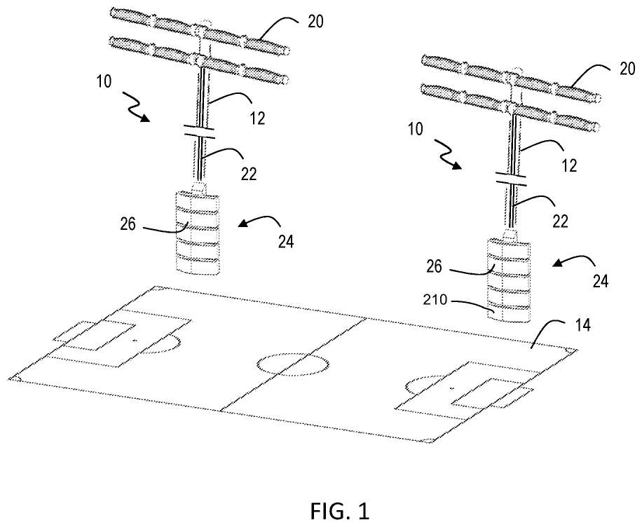

Referring to the figures, wherein like numerals refer to like parts throughout, there is seen in FIG. 1 an asymmetric source sports lighting system 10 according to the present invention. System 10 is designed for installation on a support pole 12 to provide illumination over a target area 14, such as a sporting field or pitch. The system 10 may also be used for lighting in outdoor parking areas, municipal street lighting, roadway lighting, or at any place where similar outdoor lighting systems are used. System 10 includes one or more rows of light emitting diode (LED) lighting modules 20 that extend laterally from support pole 12. Lighting modules 20 are powered via a wiring harness 22 that extends along the interior of support pole 12 and is coupled to a controller stack 24. Controller stack 24 transforms local building power from AC to DC and includes LED drivers 26 for lighting modules 20. A battery 210 is connected to support pole 12. The battery 210 may be directly connected to the controller stack 24, or the battery may be a separate unit connected by internal wiring to the controller stack 24. The controller stack 24 charges the battery 210 from transformed local building power while AC power is received by a power supply. In the event of black-out or brown-out conditions or a drop below a threshold voltage, the power supply is switched to battery power the lighting modules 20 or a subset of lighting modules. While a battery is described, a local electrical power storage of other kinds may be used in place of a battery.

In certain other embodiments, lighting modules 20 may include one or more columns of laser diodes (LD) instead of light emitting diodes. Controller stack 24, may also include LD drivers for lighting modules 20. The lighting systems described herein are LED based systems. However, the invention described could be used with LD based systems as well.

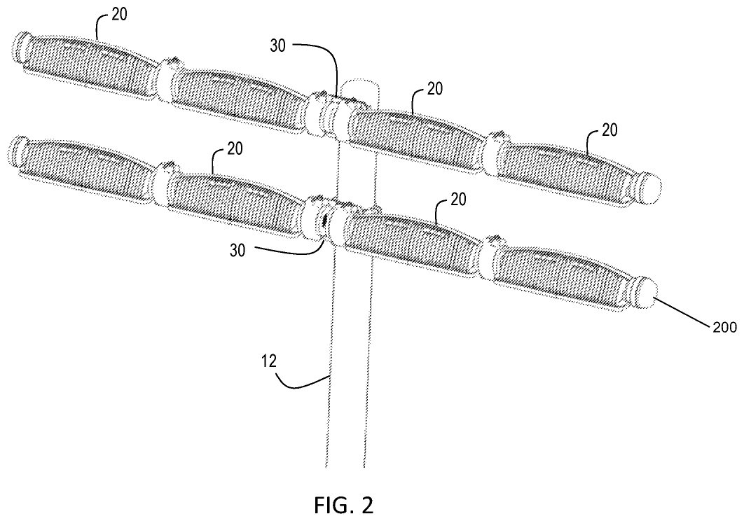

Referring to FIG. 2, a central mount 30 is coupled to pole 12 and used to support first and second lighting modules 20. Lighting modules 20 are coupled to either side of mount 30 using a modular coupling system described herein that physically supports modules 20 and electronically interconnects modules 20 to wiring harness 22 and thus controller stack 24. The opposing end of each lighting module 20 coupled to mount 30 may be used to physically support and electronically interconnect to additional lighting modules 20 extending further outwardly from support pole 12. The combination of lighting modules 20 connected to mount 30 and the additional lighting modules 20 extending to either side of pole 12 are self-supporting so that support pole 12 does not need to include physical cross-arms or lateral supports to mount additional lighting modules 20. The particular dimensions of lighting module 20 may be varied as desired. For example, lighting module 20 could be provided in two lengths, X and 2X, that may be mixed and matches as needed for a particular installation.

Continuing with reference to FIG. 2, two sets of lighting modules are depicted. The second set of lighting modules may be, for example, auxiliary emergency lighting 200. Auxiliary emergency lighting 200 may be turned off during normal lighting conditions and activated when emergency conditions arise. In other embodiments, auxiliary emergency lighting 200 may operate during normal lighting conditions but remain activated during emergency conditions.

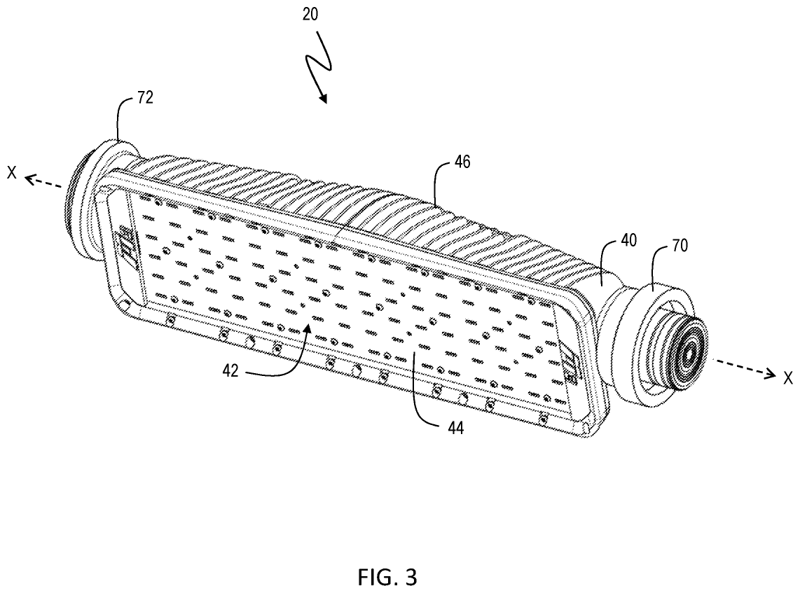

Referring to FIG. 3, each lighting module 20 includes a housing 40 extending along a longitudinal axis X-X. Housing 40 defines a rectangular opening 42 in a central portion thereof that permits access to an asymmetric illumination source 44. Asymmetric illumination source 44 is dimensioned to produce a rectangular beam of illumination from rectangular opening 42 of module 20. Housing 40 may further include fins 46 or other external structures for dispersing heat generated by using asymmetric illumination source 44.

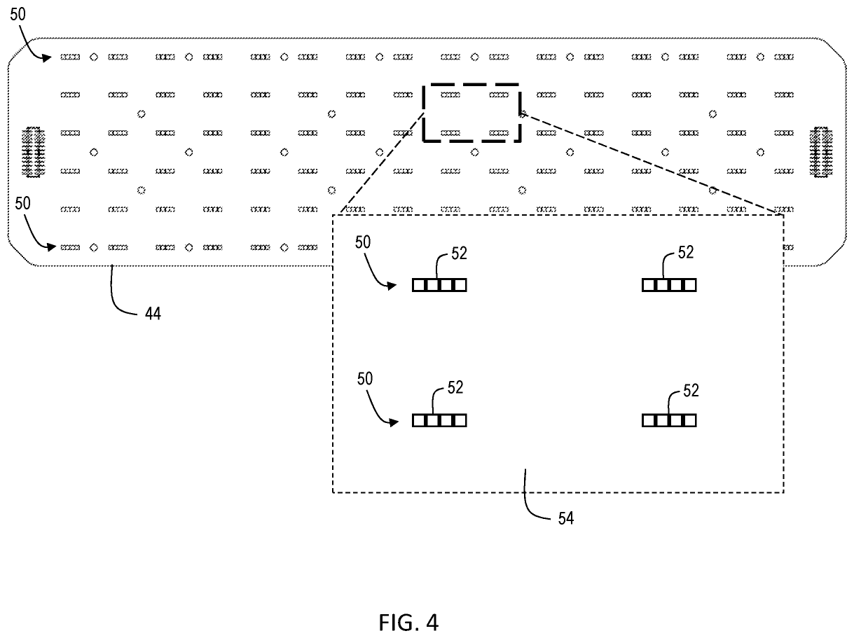

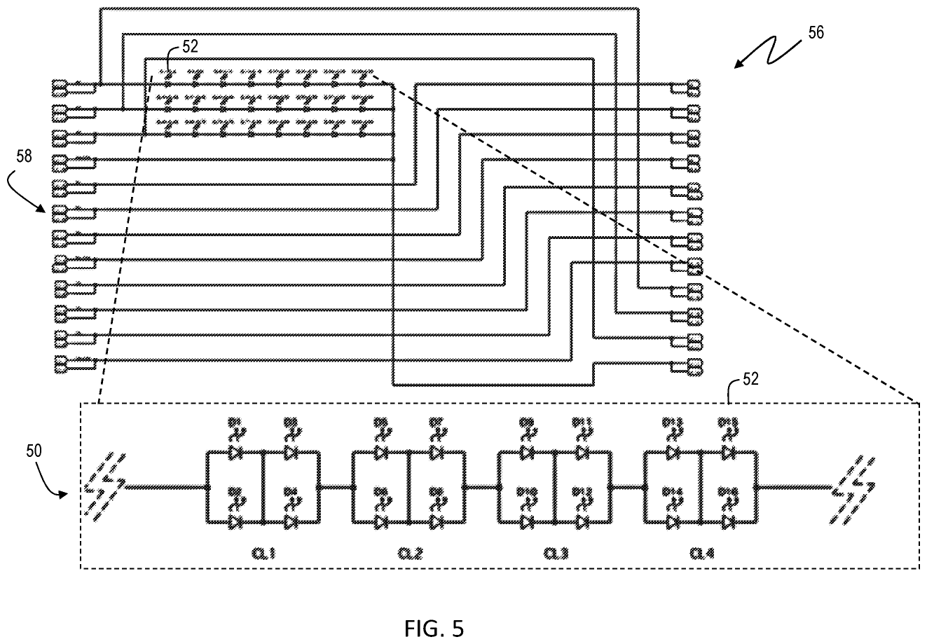

Referring to FIGS. 4 and 5, asymmetric illumination source 44 comprises multiple rows 50 of light emitting diode (LED) sets 52 spaced along a substrate 54 and coupled to electronic circuitry 56 for asymmetrically driving illumination source 44. Each row 50, or optionally, each pair of rows 50, are independently controllable by adjusting the amount of power delivered to that row (or pair or rows) using electronic circuitry 56 and controller stack 24 to provide asymmetric illumination from module 20. Optionally, a local microcontroller in each module 20 can be for further adjustment of the amount of power provided to each row (or pair or rows) of LED sets. As seen in FIG. 5, asymmetric illumination source 44 having three independently controllable rows 50 of LED sets 52. Electronic circuitry 56 further includes pass-through circuitry 58 for providing power to adjacently connected lighting modules 20 that also include independently controlled rows 50 of LED sets 52. In the example of FIG. 5, a total of two additional lighting modules 20 may be interconnected and supported by circuitry 58.

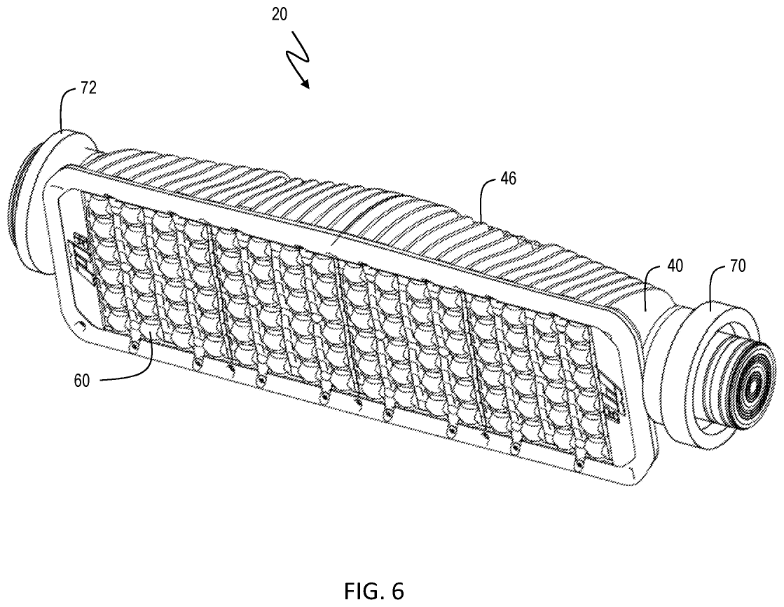

Referring to FIG. 6, a molded lens array 60 is positioned over an asymmetric illumination source 44 to reduce harshness and provide sealing of asymmetric illumination source 44 within housing 40. Housing 40 of module 20 is further configured to allow for easy coupling to the support pole and to other housings 40, forming both structural and electrical connection. Housing 40 includes a male coupler 70 positioned at one end of housing 40 and a female coupler 72 positioned at an opposing end of housing 40. Male coupler 70 is defined by a radially extending flange 74 and a circumferentially extending, outwardly facing bearing surface 76. Female coupler 72 includes a correspondingly dimensioned flange 78 and a receptacle 82 defining a circumferentially extending, inwardly facing bearing surface 77.

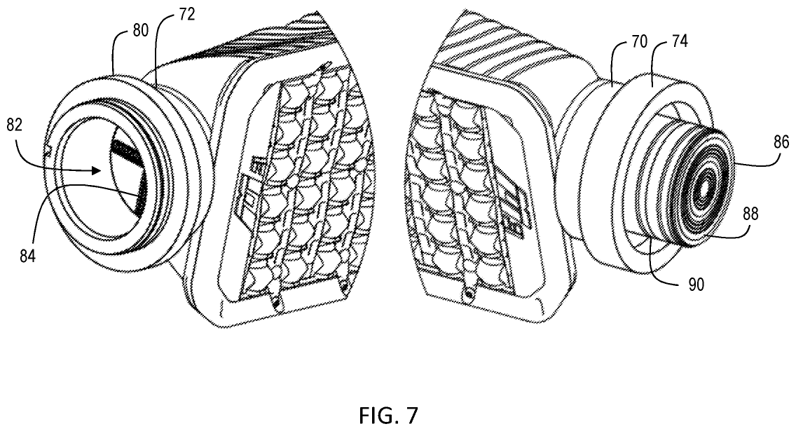

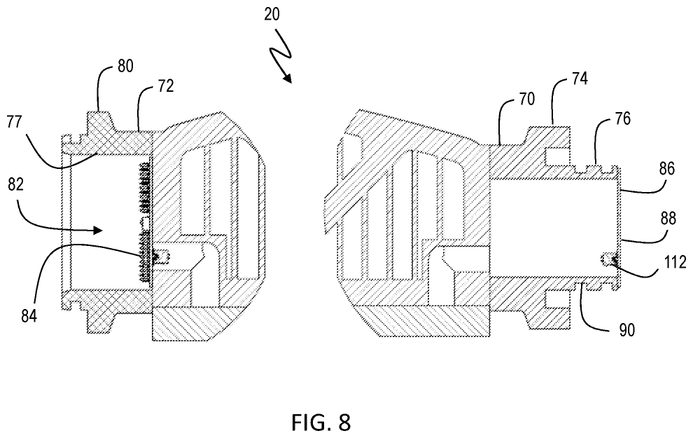

Referring to FIGS. 7 and 8, female coupler 72 further includes a set of brush contacts 84 positioned in receptacle 82 that face outwardly along axis X-X and male coupler 70 includes an end face 86 supporting set of ring contacts 88 that face outwardly in the opposite direction along axis X-X from brush contacts 84. Male coupler 70 may additionally include grooves 90 formed therein to house an O-ring for sealing purposes. It should be recognized that other contacts may be used, such as pogo pins and the like. As detailed below, brush contacts 84 and ring contacts 88 define a plurality of independent pathways for powering the independently controlled rows 50 of LED sets 52.

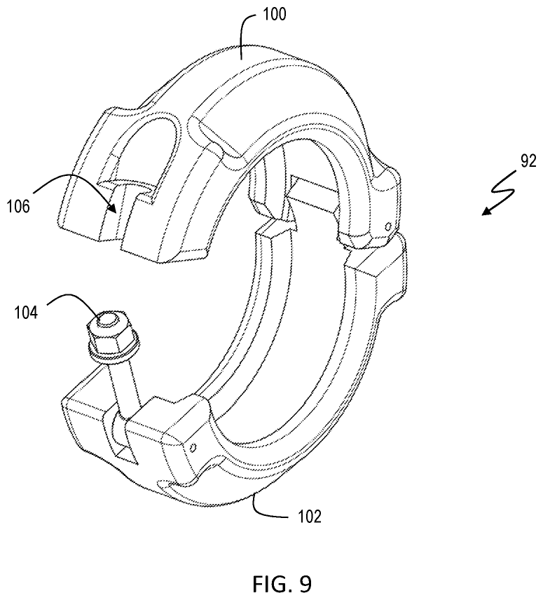

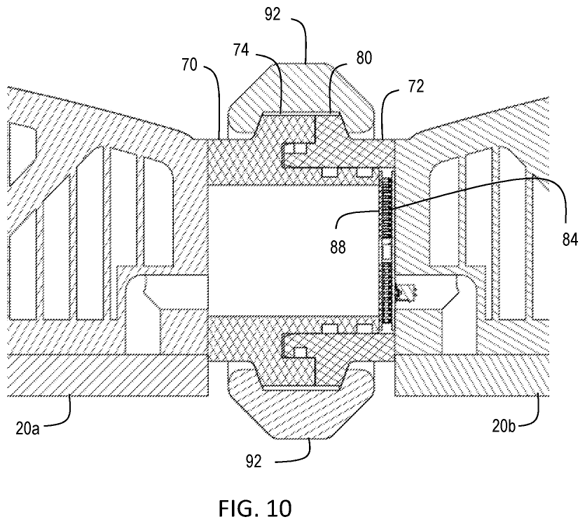

Referring to FIGS. 9 and 10, a clamp 92 may be positioned and secured in covering relation to flanges 74 and 80 to secure a first module 20 a to a second module 20 b when male coupler 70 and female coupler 72 are full joined so that bearing surfaces 76 and 77 are in seated together and brush contacts 84 and ring contacts 88 are in contact and electrically engaged. Clamp 92 comprises a pair of jaws 100 and 102 that can be opened and then closed in covering relation to flanges 74 and 80, as seen in FIG. 10, when male coupler 70 of one module 20 a is jointed with and seated inside female coupler 72 of an adjacent module 20 b. When male coupler 70 is fully inserted into female coupler 72, flanges 74 and 80 will abut and brush contacts 84 will physically and electrically engage ring contacts 88. Clamp 92 may then be closed over flanges 74 and 80 to secure first module 20 a to second module 20 b using a latch 104 on one jaw 102 that cooperates with a slot 106 in the other jaw 100, with electrical continuity between first module 20 a to second module 20 b provided via the engagement of ring contacts 88 with brush contacts 84. Adjacent modules 20 may thus be electrically interconnected when coupled together so that each module 20 has multiple independent electrical power pathways for driving the independently controllable LED rows of asymmetric illumination source 44.

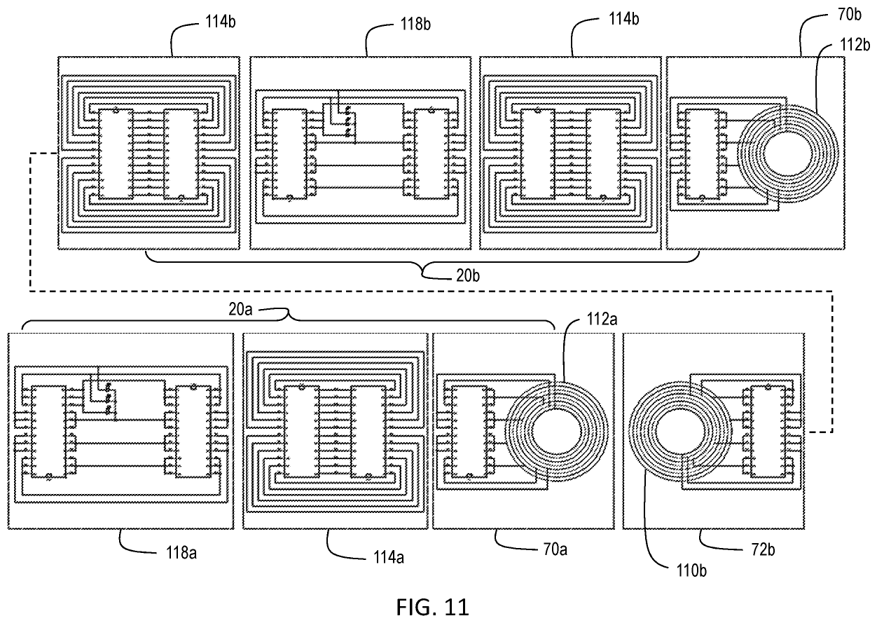

Referring to FIG. 11, module 20 b is electrically interconnected to module 20 a so that LED circuitry 118 b of module 20 b and LED circuitry 118 a of module 20 a are coupled together and under common power control. For example, coupler 70 b of module 20 b includes coupler circuitry 112 b that can receive power from ring contacts 88. Coupler circuitry 112 b is coupled to LED circuitry 118 b via cabling 114 b. LED circuitry 118 b is also coupled to coupler circuitry 110 b associated with female coupler 72 b via cabling 114 b. As a result, independent power pathways for LED circuitry 118 b extend through module 20 b and are available at coupler 70 b and coupler 72 b such as that a power supply connected to coupler 70 will also provide power to coupler 72, and vice versa. As further seen in FIG. 11, module 20 a can be electrically coupled to module 20 b via a coupler 70 a that is secured to coupler 72 b. Coupler circuitry 112 a of module 20 a is coupled to LED circuitry 114 a via cabling 114 a. Although not illustrated for simplicity, it should be evident that module 20 also includes a coupler 72 a that can be, in turn, coupled to another module 20, and so on, with the power supply for all housings 20 connected to an available coupler 70 or 72 at either end. Thus, module 20 is bi-directional and can be placed in series with additional housings 20 for common power control.

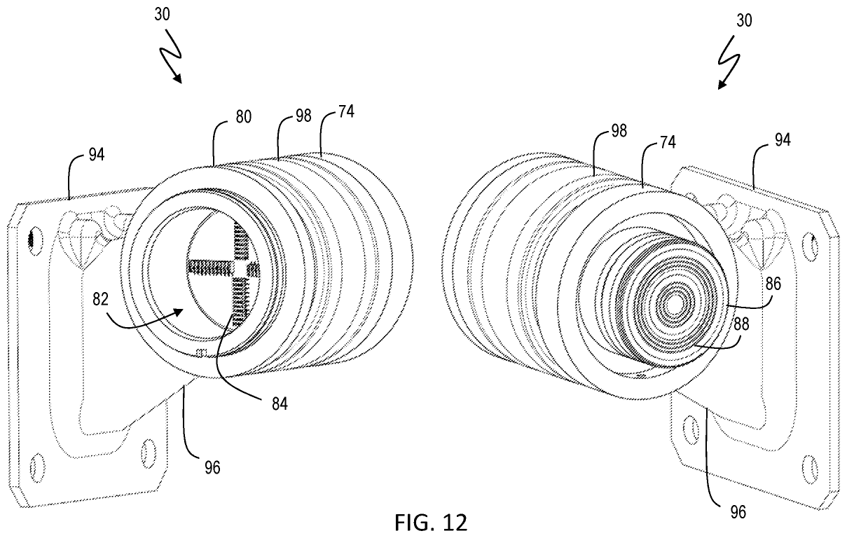

Referring to FIG. 12, mount 30 for attaching one or more housings 20 to a support pole 12 comprises a mounting plate 94 having a shaft 96 extending therefrom to support a main body 98 having male coupler 70 on one side and a female coupler 72 on the opposing side. Mount 30 suspends module 20 in spaced relation to support pole 12 to which mount 30 is attached. Male coupler 70 and female coupler 72 are configured in same manner as described above with respect to module 20, i.e., male coupler 70 includes an end face 86 having concentric ring contacts 88 and female coupler 72 has brush contacts 84 positioned within receptacle 82. Male coupler further includes flange 74 and female coupler 72 includes flange 80. As a result, module 20 may be coupled to mount 30 in the same manner as described above with respect to the connection of module 20 a to module 20 b.

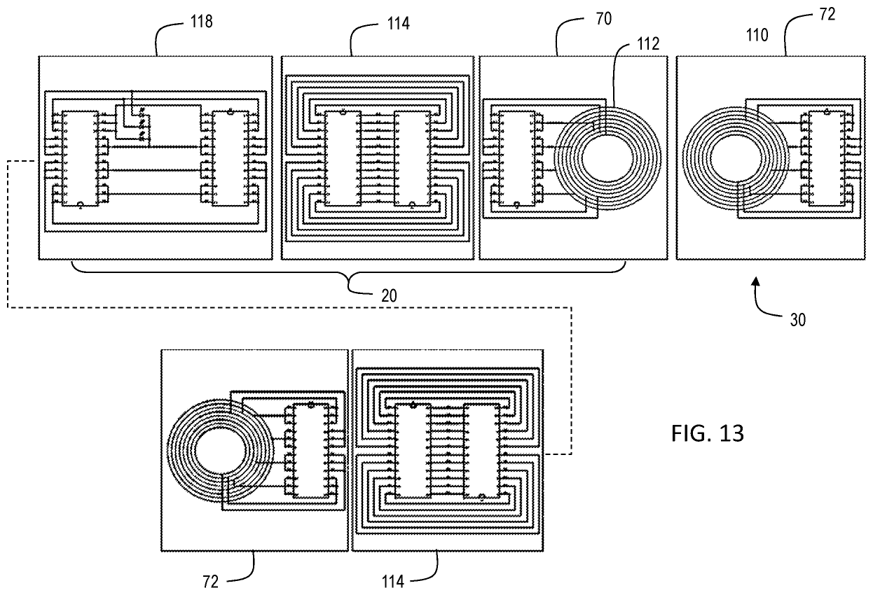

Referring to FIG. 13, joining of mount 30 to module 20 allows coupler circuitry 110 of female coupler 72 of mount 30 to connect with coupler circuitry 112 of male coupler 70 of module 20 via brush contacts 84 and ring contacts 88. Coupler circuitry 112 is coupled to LED circuitry 118 via cabling 114. LED circuitry 118 is also coupled to coupler circuitry 110 associated with female coupler 72 via cabling 114. As a result, independent power pathways for LED circuitry 118 b extend through module 20 from mount 30 and are available at coupler 70 such that a power supply connected to coupler 72 will also provide power to coupler 70. Similarly, module 20 may also be connected to the male coupler 70 of mount 30 using female coupler 72 of module 20, thus simply reversing the connections of FIG. 13 such that power is provided by mount 30 to coupler 72 with the power also made available at coupler 70 for attachment of another module 20.

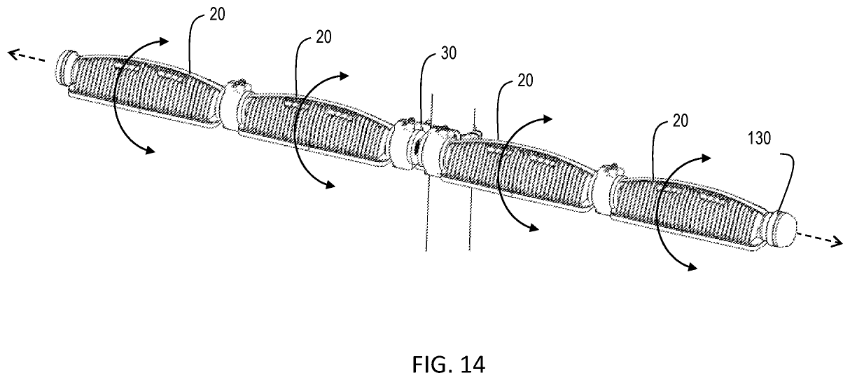

Referring to FIG. 14, cylindrical bearing surfaces of male coupler 70 and female coupler 72 allows adjacent lighting modules 20, as well as lighting modules 20 coupled to mount 30, to be rotated about longitudinal axis X-X. The orientation of the rectangular illumination provided by module 20 may thus be adjusted in a single direction, i.e., about a single axis, via rotation of lighting module 20 about axis X-X. As explained above, bearing surfaces 76 and 77 allow for physical rotation of housings 20, with brush contacts 84 and ring contacts 88 maintaining electrical continuity regardless of the rotation of housing about longitudinal axis X-X. Housings 20 may thus be easily oriented, or reoriented, as desired. While housings 20 may be manually adjusted at any time, servo motors could be incorporated into couplers 70 and 72 to allow for remote rotation of lighting modules 20 about axis X-X.

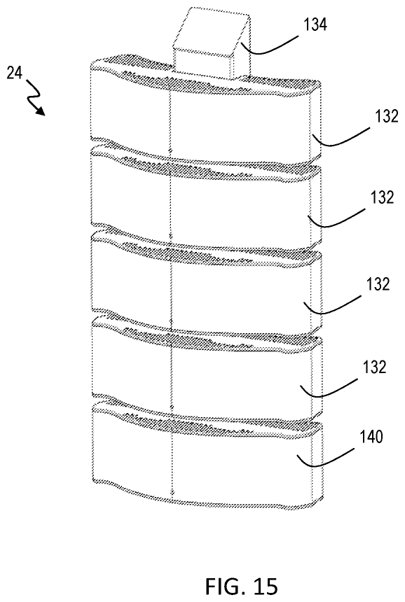

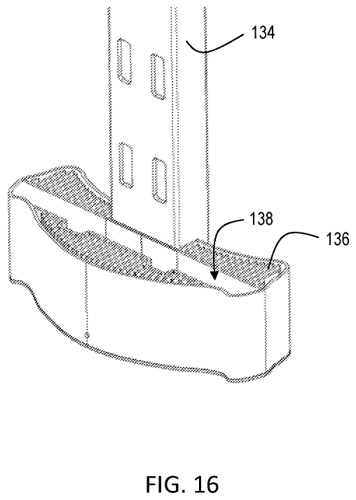

Referring to FIGS. 15 and 16, controller stack 24 comprises a series of core enclosures 132, each of which houses the power conversion and LED electronics, typically referred to as LED drivers, for an associated lighting module 20, as well as a master enclosure 140 that provides housekeeping functions. Controller stack 24 includes a back plane 134 that provides the electrical interconnections between each core enclosure 132 and master enclosure 140 as well as the requisite interconnections to wiring harness 22 to interconnect controller stack 24 to lighting modules 20. Back plane 134 is preferably adapted to act as a heat sink and transfer excess heat to support pole 12 for additional dispersion of heat generated by controller stack 24. As seen in FIG. 16, core enclosure 132 and/or master enclosure 140 include ribs 136 for dissipation of heat generated by internal electrical components positioned in a central cavity 138.

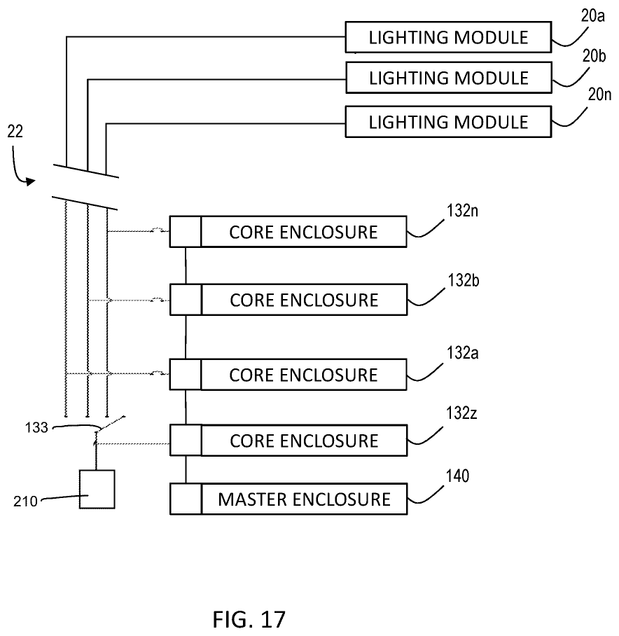

Referring to FIG. 17, each core enclosure 132 a, 132 b . . . 132 n is associated with and coupled via wiring harness 22 to a corresponding lighting module 20 a, 20 b . . . 20 n. Preferable, a backup core enclosure 132 z is selectively coupled to each lighting module 20 a, 20 b . . . 20 n via a switching circuit 133 to provide a backup power supply in the event of a fault in any of core enclosure 132 a, 132 b . . . 132 n. For example, if a fault in any core enclosure 132 results in the loss of illumination from any or all of the independently controlled rows 50 of LED sets 52 in the corresponding lighting module 20, power to that lighting module 20 can be switched to the backup core enclosure 132 z to maintain the desired amount of illumination until such time as the faulty core enclosure 132 can be repaired or replaced. Each core enclosure 132 a, 132 b . . . 132 n is also interconnected to master enclosure 140, which supervises and controls via digital commands the local operation of each core enclosure 132 a, 132 b . . . 132 n.

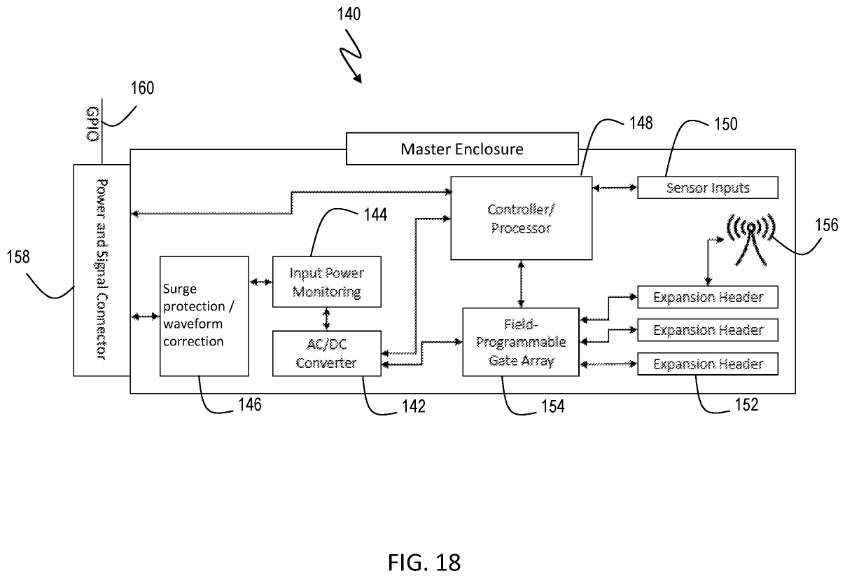

Referring to FIG. 18, master enclosure 140 is coupled to AC power via a power and signal connector 158 and includes local AC/DC conversion 142 with input power monitoring 144 as well as surge protection and waveform correction 146. Master enclosure 140 also includes a controller/processor 148 that has sensor inputs 150 for monitoring of system 10. Controller/processor 148 is also interconnected to a series of expansion headers 152 and wireless communication interface 156 via a field programmable gate array (FPGA) 154.

Controller/processor 148 may thus be programmed to establish connection with a remotely positioned host system or remote device (such as a tablet or smartphone) that can provide commands controlling operation of lighting modules 20 using expansion headers 152 to provide the desired wireless connectivity. Communication could comprise any conventional wireless communication technology or protocol, such as WiFi, Blutetooth®, BLE, ZigBee, Z-Wave, 6lo WPAN, NFC, cellular such as 4G, 5G or LTE, RFID, LoRA, LoRaWAN, Sigfox, NB-IoT, or LIDAR. Controller/processor 148 is also coupled via power and signal connector 158 for communication with core enclosures 132, such as via a general-purpose input/output (GPIO) line 160, extending in back plane 134.

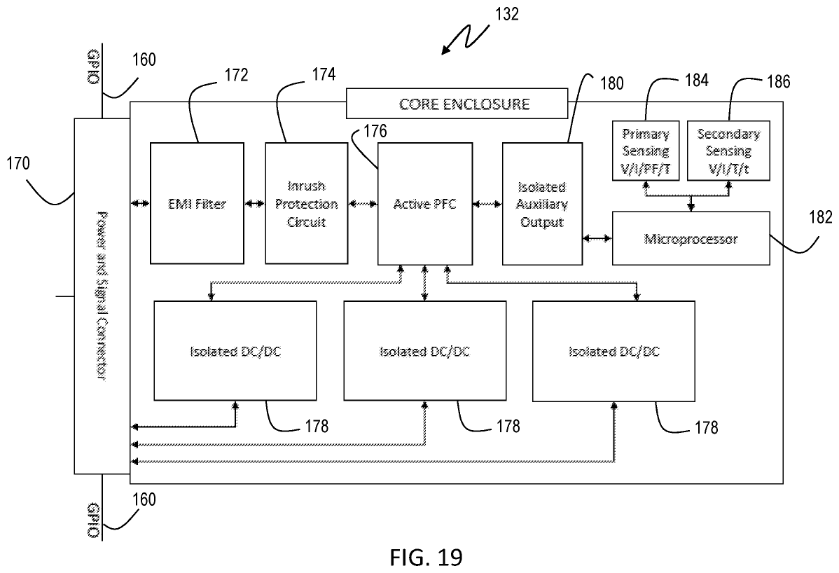

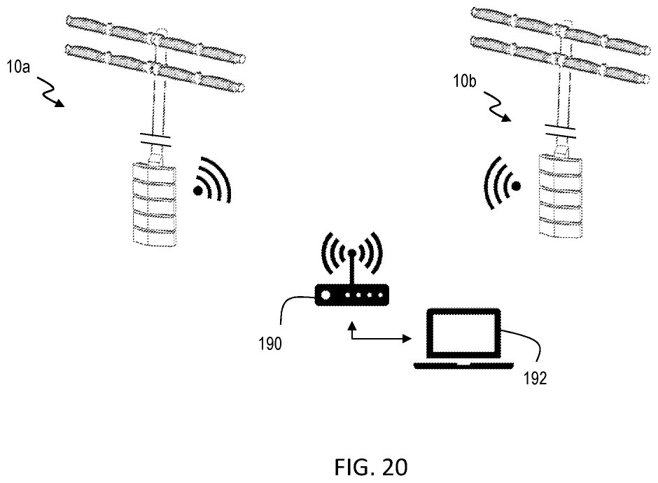

Referring to FIG. 19, each core enclosure 132 includes a power and signal connector 170, which provides connectivity to master enclosure 140 via GPIO line 160 as well as to a connection to AC power. Core enclosure 132 provides power conversion to DC and power conditioning via an EMI filter 172, an inrush protection circuit 174 and an active power factor corrector (PFC) 176. A plurality of isolated DC/DC circuits 178, each of which supports a corresponding one of independently controllable LED rows of asymmetric illumination source 44, are coupled to active PFC 176. The present invention is illustrated with three isolated DC/DC circuits because the exemplary illumination source 44 has three independently powered rows of LEDs, but if asymmetric illumination source 44 included four independently controlled rows 50 of LED sets 52, four isolated DC/DC circuits 178 would be included. Core enclosure 132 further comprises an isolated auxiliary output 180 coupled to a microprocessor 182. Microprocessor 182 is further coupled to primary sensing circuits 184 and secondary sensing circuits 186 for monitoring voltage, current, power factor, and temperature across system 10. Microprocessor 182 is further configured to adjust the power output from each of the plurality of isolated DC/DC circuits 178 based on monitoring of primary sensing circuits 184 and secondary sensing circuits 186. For example, if one of independently controlled rows 50 of LED sets 52 is not operational, microprocessor 182 can adjust the power output from the isolated DC/DC circuits 178 for the other of the independently controlled rows 50 of LED sets 52 to compensate for the loss and ensure that asymmetric illumination source 44 is providing the desired amount of illumination. Referring to FIG. 20, the wireless communication capability of master enclosure 140 provides a third layer of redundancy in the event of a partial or total loss of illumination from lighting module 20. For example, a detected loss at one location of system 10 may be communicated to wireless gateway 190 and remote host 192. The illumination output of another system 10 b may then be adjusted accordingly, either by allowing a user to send a command to system 10 b to adjust power to lighting modules 20 to compensate for the detected loss or by supervisory software residing on host 192 that automatically sends the appropriate commands.

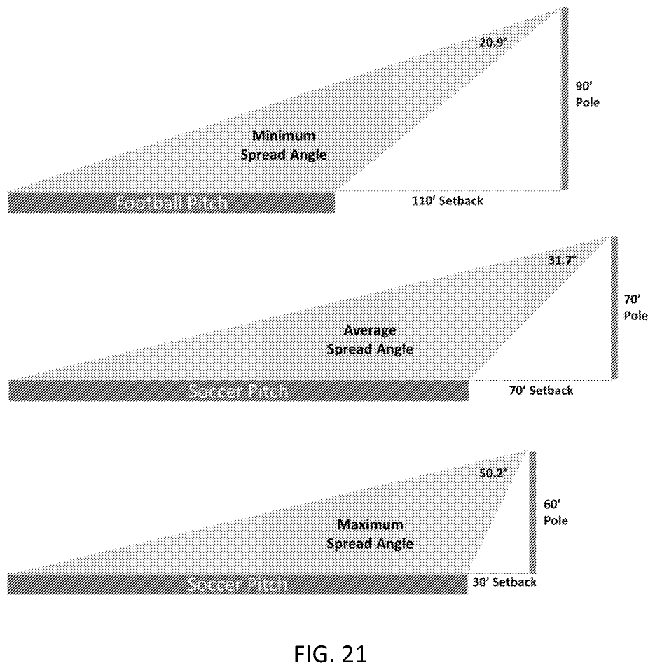

Referring to FIG. 21, asymmetric illumination source 44 of each module 20 allows for remote beam steering of lighting system 10. Lighting system 10 may be adapted to a particular installation regarding of the width of the pitch to be illuminated, the height of support pole 12, and the distance between support pole 12 and the targeted pitch. For example, asymmetric illumination source 44 may be driven to change the beam angle (generally recognized as the region of illumination with at least fifty percent of the maximum beam strength) to provide the appropriate amount of illumination between a minimum and maximum spread angle encountered in an installation. In the first scenario of FIG. 19, where the height of support pole 12 and setback distance require a minimum spread angle, asymmetric illumination source 44 can be driven asymmetrically in a first configuration to provide a narrow beam angle without having to physically reorient modules 20. In the last scenario, where the height of pole 12 and setback distance require a minimum spread angle, asymmetric illumination source 44 can be driven asymmetrically in a different configuration to provide a broader spread angle without having to physically reorient modules 20. Thus, the effective positioning of modules 20 can be adjusted without actually having to physically reorient modules 20. Thus, modules 20 may be asymmetrically driven to change the illumination scenario for different events or conditions, or to simply adjust the illumination in a given location without having to physically move lighting modules 20. FIG. 20 illustrates how the power control over each row 50 of asymmetric illumination source 44 can be adjusted to impact the beam angle emitted from lighting module 20 without having to rotate lighting module 20.

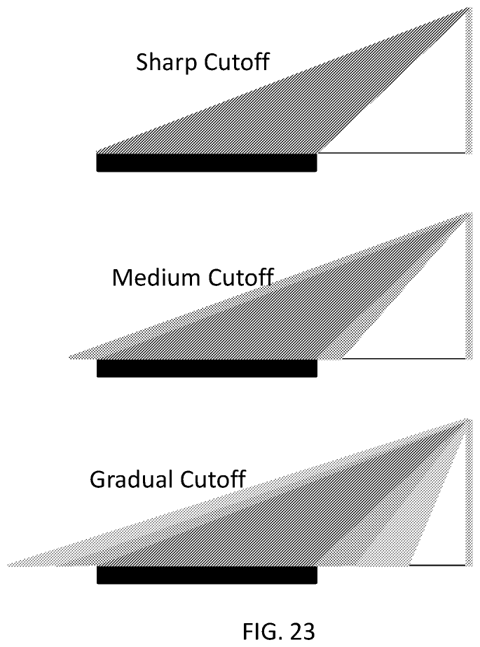

Referring to FIG. 23, asymmetric illumination source 44 of each lighting module 20 provides for a tunable cut-off for the illumination generated from lighting module 20.

Illumination cut-off generally refers to the amount of illumination in the beam field that extends beyond the desired beam angle (any area of illumination with less than fifty percent but more than ten percent of the maximum beam strength). For example, in the first scenario of FIG. 23, the cut-off is very sharp, i.e., there is very little spillage beyond the main beam angle. In the second and third scenarios, the spillage increases such that more illumination is provided ancillary to the primary beam angle. Asymmetric illumination source 44 may be driven to change the cut-off at any time, whether finally upon installation, or dynamically over time to change the lighting scheme as desired by a user for different applications. For example, a gradual cut-off may be selected when more light is desired in the areas surrounding a pitch for a particular event, such as a pre-game show, and then adjusted to provide a sharp cut-off during a game. Thus, asymmetric illumination source 44 allows for control over both the beam angle and the beam field relative to each other and relative to the illumination target.

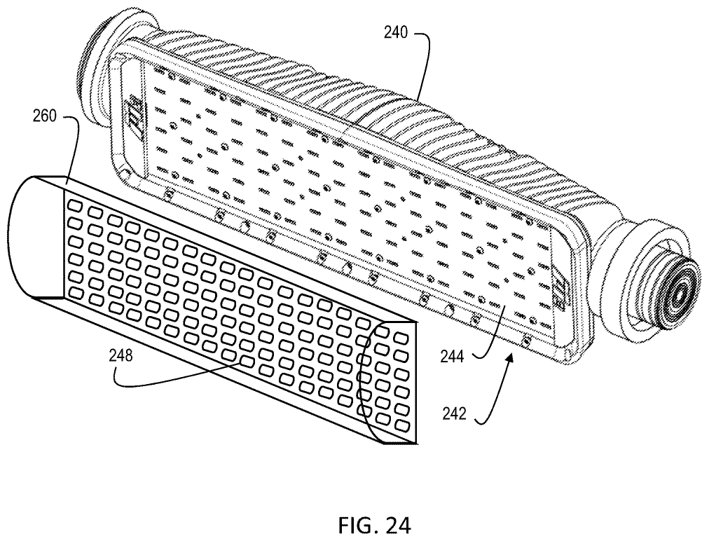

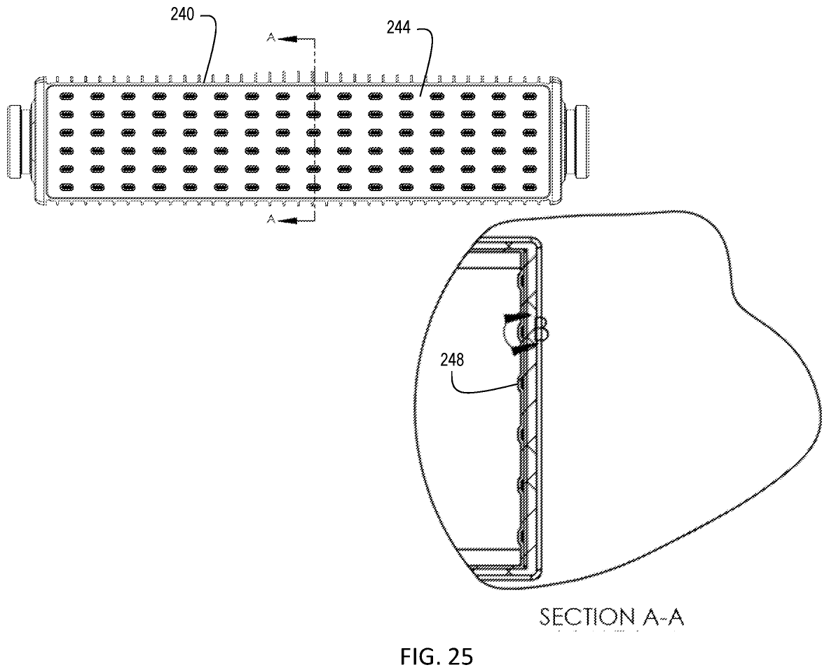

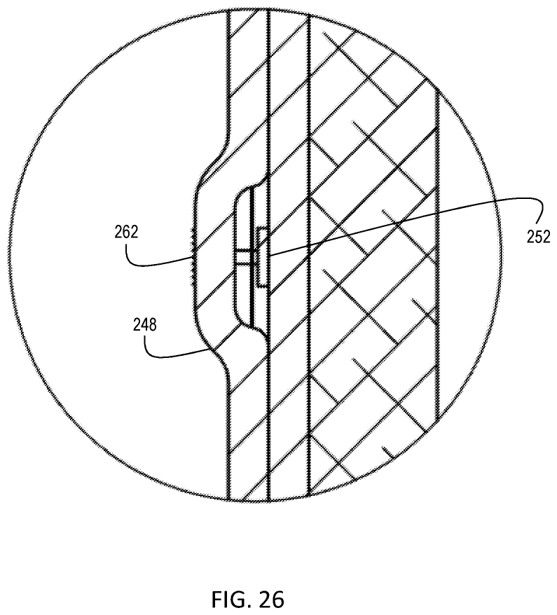

Referring to FIG. 24, lighting module 20 may be constructed using a housing 240 that encloses an asymmetric illumination source 244 and is environmentally sealed prior to attachment of lens array 260. As seen in FIG. 25, housing 240 includes a resilient optical layer 248 positioned over asymmetric illumination source 244 and captured within rectangular opening 242 to seal housing 240 from environmental infiltration. As a result, lens array 260 may be attached or removed from housing 240 in the field, such as to adjust the optical conditioning being provided, without compromising the environmental integrity of housing 240. Optical layer 248 is preferably formed from a moldable optical silicone, such as SILASTIC® MS-1002 moldable silicone and related moldable silicone compounds. As seen in FIG. 26, optical layer 248 may include micro-lenses 262 molded therein and in alignment with each LED set 252 of asymmetric illumination source 244. Optical layer 248 thus performs pre-modulation of the illumination from lighting module 20. Micro-lenses 262 allow for finer optical texturing than with lens array 260 alone. In addition, as lens array 260 does not need to perform as much optical conditioning, lens array 260 can be smaller and thus lighter than otherwise possible.

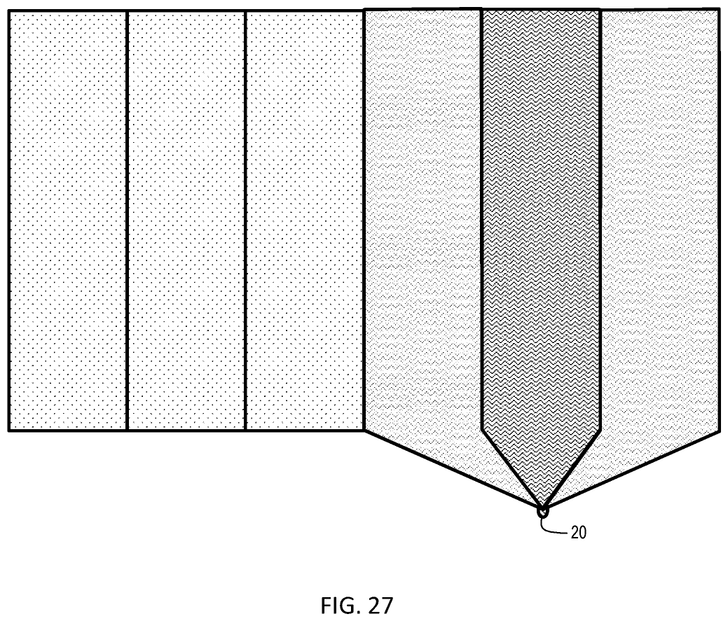

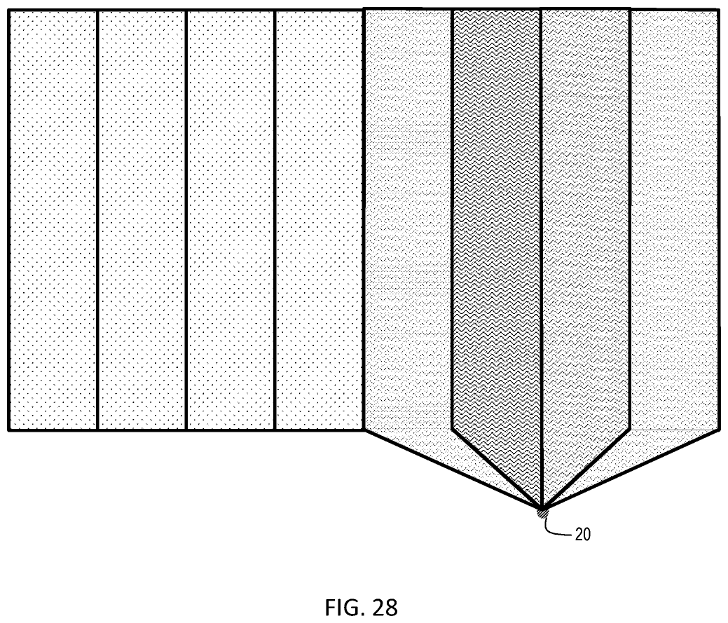

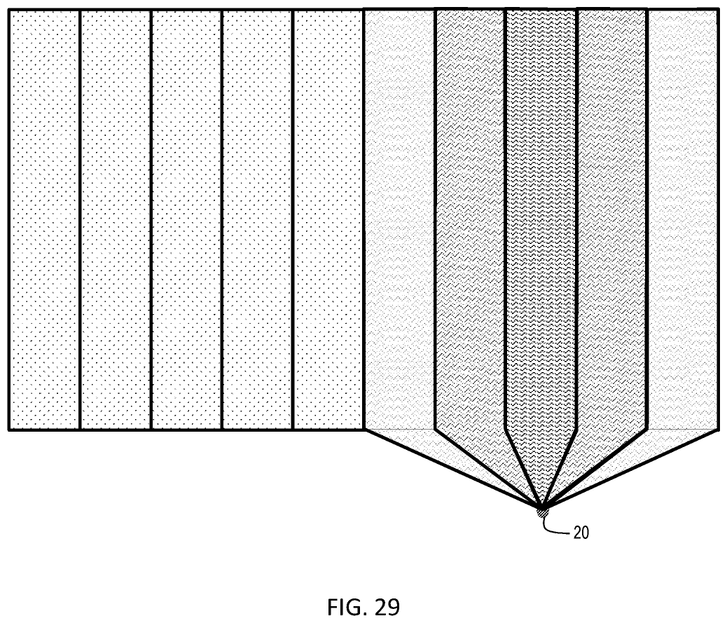

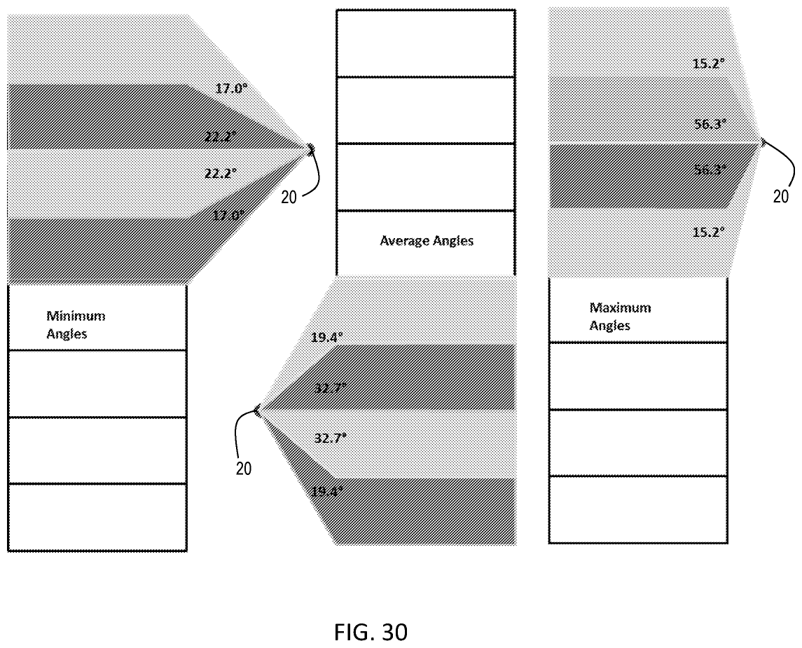

Referring to FIGS. 27 through 30, lighting module 20 may be outfitted with lens array 60 configured that steers illumination into three, four, or five different regions. For example, each particular installation may include a different number of support poles 12, so an appropriate lens array 60 distributing illumination into three, four, or five different regions may be used. As is known in the field, illumination from each support pole 12 may need to overlap with illumination for other support poles 12 to provide the desired illumination, reduce or control shadowing, etc. As seen in FIG. 30, lighting module 20 can provide a wide or narrow area of illumination using variously designed lens arrays 60 to steer illumination between a minimum and maximum distribution angle.

System 10, having lighting modules 20 and emergency auxiliary lighting 200 may lower demand for electricity by up to 80% over existing lighting systems. Battery 210 may incur a draw on system 10 but once battery 210 is fully charged, an inactive emergency system required negligible power. This lower demand may exist even with the current grid infrastructure to the stadium where system 10 is installed. By installing electrical vehicle charging systems in the stadium parking lot, electrical demand may be monetized by the stadium owner during low-demand periods or during stadium use.

The electrical vehicle charging system (“EV System”) may include a plurality of electrical vehicle chargers (“EV Chargers”) installed in a stadium parking lot and connected to existing infrastructure. Due to decreased power usage for stadium lighting system 10, the current electrical grid may be used without the need to install transformers or power control equipment.

In certain embodiments, lighting system 10 may be placed in the stadium parking lot, to provide lighting in the parking area, and modular EV Chargers may be connected to pole 12. In certain other embodiments, the EV Chargers may be connected to existing lighting poles in the parking lot or left as free standing devices for parking spaces not near lighting posts. Such charging stations may have charging cables with connectors compatible with standard electrical vehicle charging ports in the marketplace.

The EV Chargers may have two-way remote communication made possible through internet of things modules (IoT modules) offering positioning and messaging communication between the lighting System 10 and the EV System, including individual EV Chargers. IoT modules may include communication chips or services such as UBlox IoT modules or similar products and services.

System 10 may use the wireless gateway 190 to communicate with the EV System. The master controller 140 for System 10 may also act as the controller for the EV System.

In certain other embodiments a system controller may be present to coordinate power distribution between System 10 and the EV System through a smart gateway. The wireless gateway 190 may then continue to coordinate wireless communication within System 10 and the smart gateway may be used to coordinate power distribution and communication between System 10 and the EV System.

The IoT Modules within the EV Chargers may be used to send and receive wireless signals to manage and control power usage and to monitor the health and operation of each of the EV Chargers. The data exchanged by the signals may also lower or increase power output if the System 10 requires more power from the electrical grid.

A user interface on each of the EV Chargers may provide for local device control of each of the EV Chargers. The user interface may also allow customers to interact with an individual EV Charger. The Smart Gateway 190 may also allow users via an app on their phone or mobile computing device to communicate and interact with the EV Charger. For example, the EV Charger may have two-way communication with the electrical vehicle being charged and may provide information on the charging status of the vehicle. Since parking at sporting events may involve thousands of vehicles, the charging station may be able to provide location data for customers to find their vehicles after the event.

The EV Chargers may also have a payment system integrated with the user interface or accessible by the user interface. The user interface may also have alarms to signal the user if charging rises above a threshold value or if there is some kind of error or fault within the device.

As part of a health-status check, the system controller may receive error or fault communications from the EV Chargers. A management user interface on a computing device, phone, or mobile computing device may be used to receive and display, location and health-information of the EV Chargers. The management user interface may also be configured to provide control of the EV Chargers and reset and repair functions.

Other two-way controllable features may also be present to provide for system control and feedback.

The modular configuration of the EV Charger may provide for addition or subtraction of features and components of the EV Charger, forming a configurable EV Charging System. The Charging System may be configured or expanded based on, for example, the location of a stadium or venue, the current grid infrastructure, or even the event at the stadium of the venue.

The EV Charging System may have a storage battery or storage batteries providing for charging in, for example, emergency situations or situations where draw is at the capacity of the grid infrastructure. In the event of an emergency, it may also be possible to configure the EV Chargers to draw power from storage battery and/or the electrical vehicle being charged, to provide lighting to the parking lights or the stadium lights. An emergency may include a black-out or a brown-out. The emergency may also be signaled by the lighting system where the controller stack provides a signal from the wireless gateway 190 to the internet of things module

Each of the EV Chargers may have its own battery. The modular configuration may provide for configurations where parts from one EV Charger are used to repair another charger.

In a certain embodiment, a lighting system, having at least one lighting module, the lighting module having a housing extending from first end to a second end along a longitudinal axis and having an elongated opening in alignment with an illumination source within. A first coupler may be positioned at the first end of the housing and may have an end face having a first set of electrical contacts. The first coupler may also have a first set of auxiliary electrical contacts. A second coupler may be positioned at the second end of the housing and have an internal bore. The internal bore may have a second set of electrical contacts and a second set of auxiliary electrical contacts within. An auxiliary lighting module may have a housing having an opening and an illumination source within. A coupler connected to the auxiliary lighting module housing may have a set of auxiliary module electrical contacts and the coupler may be configured for connection to one of the first coupler or the second coupler. A local power source may be connected to a controller stack. The controller stack may be connected to the at least one lighting module by a first set of wiring, and connected to the auxiliary lighting module by a second set of wiring. The controller stack may have an alternating current power supply, a wireless, and a switching circuit. The switching circuit may have a voltage monitor connecting the alternating current power supply and the first set of wiring, and the local power source and the second set of wiring. The voltage monitor may measure for a voltage drop based on a threshold value. The first set of electrical contacts may be connected to the second set of electrical contacts internally, within the lighting module housing. The second set of wiring may connect the first set of auxiliary electrical contacts and the second set of auxiliary electrical contacts. The lighting system may be connected to the pole 12. A plurality of lighting systems may be connected to a plurality of poles. A plurality of electrical vehicle chargers may be connected to the controller stack of each of the plurality of lighting systems. Each of the plurality of electrical vehicle chargers may have: an electrical vehicle charging cable configured for connection to an electrical vehicle, a connection to an existing power grid, a modular configuration, an internet of things module configured for two-way, wireless communication with a wireless gateway 190, a feedback system, and a control system connected to and configured for communication with the internet of things module, the existing power grid, and the electrical vehicle charging cable. The electrical charger may have a user interface configured to receive commands to control the electrical charger and to provide display feedback to a user.

In certain embodiments, the power supply may be a direct current power supply. In certain other embodiments, the power supply may be an alternating current power supply, and the controller stack may have a rectifier to provide direct current (DC) to any drivers or circuitry within the controller stack and to provide DC to the lighting modules.

As described above, the present invention may be a system, a device, a method, and/or a computer program associated therewith and is described herein with reference to flowcharts and block diagrams of methods and systems. The flowchart and block diagrams illustrate the architecture, functionality, and operation of possible implementations of systems, methods, and computer programs of the present invention. It should be understood that each block of the flowcharts and block diagrams can be implemented by computer readable program instructions in software, firmware, or dedicated analog or digital circuits. These computer readable program instructions may be implemented on the processor of a general purpose computer, a special purpose computer, or other programmable data processing apparatus to produce a machine that implements a part or all of any of the blocks in the flowcharts and block diagrams. Each block in the flowchart or block diagrams may represent a module, segment, or portion of instructions, which comprises one or more executable instructions for implementing the specified logical functions. It should also be noted that each block of the block diagrams and flowchart illustrations, or combinations of blocks in the block diagrams and flowcharts, can be implemented by special purpose hardware-based systems that perform the specified functions or acts or carry out combinations of special purpose hardware and computer instructions.

What is claimed is:

1. An electrical vehicle charging system comprising:
a lighting system comprising:
a controller stack connected to:
a lighting module and an auxiliary lighting module by wiring; and
a wireless communication gateway
an alternating current power supply;
a switching circuit;
and a local power storage device;
a plurality of electrical vehicle chargers each comprising:
an electrical vehicle charging cable configured for connection to an electrical vehicle;
a connection to an existing power grid;
an internet of things module configured for two-way, wireless communication with a wireless gateway;
a feedback system;
a control system connected to and configured for communication with the internet of things module, the existing power grid, and the electrical vehicle charging cable.

2. The lighting system of claim 1, wherein each electrical vehicle charger has a modular configuration.

3. The lighting system of claim 1, wherein the local power storage device is a battery.

4. The lighting system of claim 1, wherein each of the plurality of electrical vehicle chargers have a local power storage device, and the local power storage device is connected to the existing power grid.

5. The lighting system of claim 1, wherein the local power storage device of each of the plurality of electrical vehicle chargers is a battery.

6. The lighting system of claim 1, wherein a user interface configured to receive input and send commands to control the electrical charger and to provide display feedback to a user.

7. The lighting system of claim 1, wherein the electrical vehicle charging cable is configured to provide power to the electrical vehicle when connected to the electrical vehicle.

8. The lighting system of claim 1, wherein the electrical vehicle charging cable is configured to draw power from the electrical vehicle to the existing power grid when connected to the electrical vehicle and an emergency signal is received by the internet of things module.

9. The lighting system of claim 4, wherein local power storage device provides power to the existing power grid when an emergency signal is received by the internet of things module.

10. The lighting system of claim 9, wherein the electrical vehicle charging cable is configured to draw power from the electrical vehicle to the existing power grid when connected to the electrical vehicle and the emergency signal is received by the internet of things module and the local power storage device power output falls below a defined threshold.

11. The lighting system of claim 1, wherein internet of things module sends and receives signals to manage and control power usage.

12. The lighting system of claim 1, wherein the internet of things module sends and receives signals to monitor the operation of each of the plurality of electrical vehicle chargers.
